(19) United States
(12) Patent Application Publication
(10) Pub. No.: US 2025/0058513 A1
(43) Pub. Date: Feb. 20, 2025

(54) PARTIAL OPENING DEVICE FOR THE PRE-OPENING OF GRIPPERS

(71) Applicant: Brückner Maschinenbau GmbH, Siegsdorf (DE)

(72) Inventor: Tobias HÄUSL, Traunstein (DE)

(21) Appl. No.: 18/801,014

(22) Filed: Aug. 12, 2024

(30) Foreign Application Priority Data
Aug. 14, 2023 (DE) 10 2023 121 737.2

(51) Int. Cl. B29C 55/20; B29C 31/00; B29C 55/12; B29L 7/00

(52) U.S. Cl. CPC B29C 55/20; B29C 31/00; B29C 55/12; B29L 2007/008

(57) ABSTRACT

A partial opening device for pre-opening grippers, in particular grippers of a stretching unit, comprises at least one partial opening disc and a drive, wherein the drive is configured to drive said at least one partial opening device. The partial opening disc has a circumferential surface comprising a rotating contact surface, wherein the contact surface is configured to engage with a blade flap of a gripper when the gripper is guided past the partial opening disc so that the gripper is pre-opened.

### CROSS-REFERENCE TO RELATED APPLICATIONS

This application claims priority to DE Patent Application No. 102023121737.2 filed Aug. 14, 2023, the entire contents of which are hereby incorporated by reference.

### FIELD

The present technology relates to a partial opening device for pre-opening grippers, in particular grippers of a stretching unit, an opening system for opening grippers, a stretching unit comprising such an opening system as well as a method for opening grippers.

### BACKGROUND

Stretching units are used in particular in the production of plastics films and stretched textiles. Normally, the material web to be stretched, in general a plastics film, is gripped in such units by means of gripper units or grippers and moved through the unit. The grippers are moveably arranged on revolving guide rails and are driven centrally or independently.

In particular, the material web to be stretched is gripped in an entry zone by means of grippers which are arranged moveably on both sides of the material web to be stretched on revolving guide rails. The grippers are moved one after another from an entry zone via a stretching zone to an exit zone and then are returned once again to the entry zone, wherein the film can be subjected to, for example, predetermined relaxation and/or thermal post-treatment in the exit zone.

To grip/to take hold of the material web in the entry zone, the grippers are moved from an open position to a closed position (gripping position). Typically, a gripper comprises at least two clamping faces that are substantially opposite to each other and used to grip the material web. By actuating a lever (also termed blade flap), the clamping faces can be moved towards each other into the gripping position. In addition, the blade flap is used to open the gripper in order to release the material web after being stretched. In particular, the grippers must be opened again after the stretching process. The opening usually takes places after the stretched film has been fed by means of the grippers through a further heating zone or cooling zone. After the grippers are returned on a revolving guide rail, they grip the material web once again (at another place) and then move through the stretching region of the stretching unit once again. The grippers must be open in order to be capable of gripping the material web again.

In existing stretching units, in particular film stretching units, the opening of the grippers is not always reliable so that the open position of the gripper is not attained. In this case, the gripper remains in a partially opened state or even closes itself again. Thus, these grippers cannot grip the material web again so that there is a risk of damaging the stretching unit and/or the film to be stretched. To prevent this, mechanical forced opening devices are often used. Known forced opening devices, such as opening wheels or opening strips, provide a stop which strikes grippers not completely opened or closed grippers when these grippers are guided past the forced opening device. The grippers are forced opened by means of the stop.

This striking of the stop and rapid opening however results in very high mechanical stresses so that the service life of the grippers is reduced considerably. If a part of the gripper, such as the blade flap or another part of the gripping mechanism, breaks due to the impact stress, it can also result in other parts of the film stretching unit being damaged and/or outage times and thus production losses.

Such forced openings are to be avoided particularly in the case of high-speed stretching units (for example, production speed of >500 m/min with a corresponding gripper travelling speed) for example for producing PET, PE, PP, PA films and suchlike, such as BO units, i.e. units in which the film is stretched in the transverse and longitudinal directions. However, the opening rate of known magnetic—and thus non-impact—opening devices sinks with increasing gripper travel speed. In addition, the opening rate of known non-impact opening devices is often insufficient if the grippers are difficult to open. This is the case, among other things, in the case of large film thicknesses, in the case of stuck blade flaps or in the case of high transverse film tension (i.e. in the case of high transverse stretching forces).

### BRIEF DESCRIPTION OF THE DRAWINGS

Features and advantages of example non-limiting embodiments are found in the following description as well as the attached drawings to which reference is made.

In the drawings:

FIG. 1 shows a schematic view of a stretching unit;

FIG. 2 shows a further schematic view of a stretching unit;

FIG. 3 shows a schematic view of a gripper unit;

FIG. 4 shows a schematic detailed view of a gripper unit;

FIG. 5 shows a schematic view of an opening system;

FIG. 6 shows a schematic view of a partial opening disc of a partial opening device;

FIG. 7 shows a schematic view of a partial opening device; and

FIG. 8 shows a flow diagram of a method for opening grippers.

### DETAILED DESCRIPTION OF EXAMPLE NON-LIMITING EMBODIMENTS

Example embodiments of technology herein provide a device and a method which enables the reliable opening of the grippers-even at high gripper travel speeds and/or in the case of grippers that are difficult to open.

The technology provides a partial opening device for pre-opening or for fully opening grippers, by means of an opening system for the complete opening of the grippers, by means of a stretching unit and by means of a method for opening grippers. Further aspects are specified in the following description.

In particular, the technology provides a partial opening device for pre-opening grippers, wherein the grippers can be the grippers of a stretching unit, in particular a film stretching unit. The technology is not limited, however, to film stretching units, but can also be used, for example, in connection with stretching textiles or other materials. Further fields of application are also possible.

The partial opening device does not open the gripper completely. This means that the gripper does not move from the closed position into the open position by means of the partial opening device. In particular, the partial opening device is configured to only pre-open such grippers requiring pre-opening in order to be open completely or the partial opening device can be configured to pre-open all grippers being guided past.

In the case of pre-opening the grippers, the gripper is only partially opened by the partial opening device. For example, the partial opening device moves the gripper from the closed position, without completely opening the gripper. The additional opening process is controlled subsequently by an opening device, preferably by a non-contact opening device (for example a magnetic opening device). In this case, the partial opening device is upstream of the opening device, or positioned in a front region of the opening device so that the opening device can take over the pre-opened gripper.

In a first application, only a part of the gripper is to be pre-opened, in particular the part of the grippers that have a degree of opening below a predefined degree of opening when being guided past the partial opening disc. In this case, the partial opening device is positioned in a (front) region of the opening device. The predefined degree of opening can correspond in this case to the degree of opening to which the opening device would have moved the grippers in the case of the correct functioning of the opening device.

The grippers that do not have the predefined degree of opening are then pre-opened by the partial opening device when being guided past. That the grippers do not have the predefined degree of opening may be due to the fact, for example, that the gripper (or its blade flap) is stiff and/or adheres firmly to the film edge of the film to be stretched. The grippers pre-opened by the partial opening device are then opened completely by the actual opening device (for example a magnetic opening device).

In a second application, all grippers are to be pre-opened. To this end, the partial opening device is positioned before the actual opening device. The grippers being guided past are then opened, thus pre-opened, by the partial opening device and in the pre-opened state transferred to the actual, preferably magnetic opening device.

In a further aspect, the partial opening device can be provided for opening the grippers fully. In this case, the partial opening device is positioned downstream of the opening device or in a region of the opening device. In this case, the partial opening device takes on the already partially opened grippers from the opening device and initiates the further, subsequent opening process of the already partially opened grippers. When fulling opening the grippers, the partial opening device can guide the grippers past a tipping point or even into the completely open position. The tipping point is understood to mean a point at which—provided it has been exceeded—the gripper or the blade flap completely opens reliably.

By means of the partial opening device, it is also possible to prevent that (i) the opening device does not completely open the grippers (in particular by means of pre-opening) and/or (ii) that already (partially) opened grippers remain in the partially opened state or close again (in particular by means of full opening).

The partial opening device comprises at least one partial opening disc and a drive, wherein the drive is configured to drive said at least one partial opening device. The partial opening disc is in particular rotated by the drive.

The partial opening disc comprises a circumferential surface, wherein the circumferential surface has a rotating contact surface. This contact surface is configured to engage with a blade flap of a gripper when the gripper is guided past the partial opening disc and if the gripper, when being guided past the partial opening disc, has a degree of opening below a predefined degree of opening so that the gripper is pre-opened or optionally opened fully.

In the first application, thus when only a part of the gripper is to be pre-opened, the partial opening device is positioned in the region of the opening device, preferable in a front region of the opening device (the partial opening device is thus connected in parallel to the opening device). The predefined degree of opening can correspond in this case to the degree of opening in which the opening device would have moved the grippers in the case of the correct functioning of the opening device when these are guided past the partial opening device. Thus, only the grippers guided past that have been opened by then insufficiently by the opening device are pre-opened by the partial opening device. After passing the partial opening device, all grippers are then opened partially (either when functioning correctly by the opening device, or by the partial opening device) so that the opening device can take over the grippers and the remaining opening can be implemented. The pre-opened grippers are thus opened further by the opening device after being guided past the partial opening device.

If all grippers are pre-opened (second application), the partial opening device can be upstream of the opening device. The predefined degree of opening can be determined in this case in such a way that it corresponds substantially to a closed position of the gripper. Thus, all grippers being guided past are pre-opened by the partial opening device and the partially opened grippers transfer to the opening device in order to be opened completely.

If the gripper is to be opened fully, in particular the part of the grippers that have a degree of opening below the predefined degree of opening when being guided past the partial opening disc, the partial opening device can be positioned in the region of the opening device (thus connected in parallel to the opening device) or be downstream of the opening device. The predefined degree of opening can correspond in this case to the degree of opening that the grippers typically have when leaving the opening device (in the case of the correct functioning of the further opening device). Thus, the grippers being guided past that have only been opened by then insufficiently by the opening device are opened fully by the partial opening device. The grippers opened insufficiently by the opening device are ultimately opened fully by the partial opening device.

For the pre-opening, the predefined degree of opening can be, for example, at least 1% or at least 5% or at least 10% or at least 15%, and for full opening, for example, at least 85% or at least 90% or at least 95%. The predefined degree of opening can be set in particular by the position of the partial opening disc.

Through pre-opening, the time for opening the gripper is extended in comparison to conventional opening devices so that the grippers are mechanically stressed less strongly. Thus, not only a complete opening can be ensured, but the service life of the grippers can also be increased. This applies analogously for full opening.

In pre-opening, there is a mechanical contact between the contact surface of the partial opening disc and the blade flap of the gripper concerned. The position and/or diameter of the partial opening disc can be selected in such a way that always only one gripper is in contact with the rotating contact surface. Similarly, the position and/or diameter of the partial opening disc can be selected in such a way that several (at least two) grippers can be simultaneously in contact with the rotating contact surface. In comparison to a forced opening device, however, the mechanical stress is considerably reduced as the gripper is only opened partly and as the relative speed between the gripper or its blade flap and the partial opening disc can be reduced or even set to zero due to the driven partial opening disc.

According to an aspect, the partial opening device can pre-open a gripper with a degree of opening ranging from greater than 0% up to at least 5%, preferably up to at least 10% and particularly preferably at least 15%. According to an aspect, the (or a further) partial opening device can open a gripper fully from a degree of opening of at least 95%, preferably at least 90% and particularly preferably at least 85%. The percentages relate to a distance that the clamping face(s) of the gripper move(s) transitioning from the closed state to the opened state.

The partial opening of the grippers enables the reliable opening of the grippers, among other things, even when
the gripper (or the blade flap and/or at least one clamping face) jams,
at least one clamping face adheres and/or becomes stuck to the material web to be conveyed,
residual material and/or deposits make opening the gripper more difficult, and/or
owing to the high gripper travel speed, the inertia of the moveable parts of the grippers makes opening the gripper more difficult.

In particular, the drive can be configured to be synchronised to a gripper travel speed. The synchronisation of the drive to the gripper travel speed can occur in such a way that no slip substantially exists between the grippers to be opened partly and the partial opening disc, or a desired slip can be set. For example, the drive can be synchronised in such way that the contact surface of the partial opening disc, in relation to a gripper to be opened partly, has slip in the range of −10% to +10%, preferably in the range of −5% to +5% and particularly in the range of 0% to +3%. Thus, the mechanical stress in striking the grippers (or their blade flaps) on the contact surface can be reduced and the pre-opening (or full opening) can be guided by the partial opening disc. Thus, the service life of the grippers and the partial opening disc can be extended.

The drive can be a direct drive or an indirect drive. For example, the drive can comprise a belt drive or chain drive and/or an electric motor, for example a synchronous motor.

In addition, a position of the partial opening disc can be adjustable in the TD direction and/or the MD direction. Thus, the predefined degree of opening can also be set. To adjust the position of the partial opening disc, the partial opening device can comprise at least one positioning device, or the adjustment can be undertaken manually. Said at least one positioning device can comprise, for example, at least one linear motor and/or one linear guide. Similarly, the positioning device can comprise a transmission, for example a trapezoidal threaded spindle that transforms a rotating drive motion into a linear motion.

The term MD direction refers to the “machine direction”, while the term TD direction refers to the “transverse direction”. The MD direction relates to the direction in which the material web (in particular a plastic film) is fed through the stretching unit. It is also the primary direction of travel along the length of the material web. In contrast, the TD direction relates to the direction that is perpendicular to the MD direction (in the plane of the material web).

Furthermore, the position of the partial opening disc can be adjustable in the vertical direction. The vertical direction is a direction that is vertical on the plane of the material web. Thus, the partial opening disc can be positioned in three directions (MD, TD and vertically). The adjustment in the vertical direction can occur manually. In particular, the vertical position can be specified once (e.g. during assembly via elongated holes), or the vertical position is adjustable manually. To this end, a positioning device can be provided.

Preferably, the position of the partial opening disc is adjustable in the MD, TD and/or vertical direction independently of each other. To this end, separately drivable/adjustable motion axes or positioning devices can be provided.

In particular, the partial opening device can comprise a control device that can change the speed of the partial opening disc. To this end, the control device can control the drive. Thus, a desired slip of the partial opening disc can be set.

The optimal position of the partial opening disc is dependent on the film edge thickness of the material web to be transported. The film edge thickness is here the thickness of the material web (in particular the plastic film) that can be measured between the clamping faces of the gripper in the closed state when the gripper has gripped the material web. As the position of the blade flap changes with the film edge thickness, the position of the contact point also changes, i.e. the point at which the blade flap first contacts the rotating contact surface of the partial opening disc. Through the positioning of the partial opening disc in the MD, TD and/or vertical direction, a desired contact point (and thus a predefined degree of opening below which there is pre-opening or full opening) can be set, depending on the film edge thickness, so that mechanical loads as low as possible occur in pre-opening and/or full opening and the grippers can be opened reliably.

For ideal pre-opening, the partial opening disc is positioned in such a way, for example, that a non-contact opening device (e.g. a magnetic opening device) has the option to subsequently completely open the pre-opened gripper reliably. After the pre-opening, the non-contact opening device takes on the pre-opened grippers and continues the opening process. The transfer of the grippers occurs preferably in such a way that the opening process is continued, i.e. before the pre-opened grippers begin to close themselves again. Similarly, for ideal full opening, the partial opening disc is positioned in such a way, for example, that a parallel or forward non-contact opening device (e.g. a magnetic opening device) transfers the already largely opened grippers or grippers not opened correctly to the partial opening device which then executes the full opening. As described above, the partial opening device can be configured to only pre-open such grippers requiring pre-opening in order to then be completely opened by the opening device (first application), or the partial opening device can be configured to pre-open all grippers being guided past (second application).

For example, the film edge thickness can be entered in a user interface of a computing device for the purpose of positioning the partial opening disc. Then, the ideal position of the partial opening disc can be calculated and the partial opening disc can be positioned accordingly manually.

In particular, the contact surface of the partial opening disc can comprise a contoured cross section. This contoured cross section can be adjusted to a contact region of a blade flap of a gripper to be opened partly, preferably in such a way that a position of the contact point in the MD direction is independent of the film edge thickness of the material web (e.g. film) held by the gripper to be opened partly. The contour enables ideal pre-opening or full opening to be attained and thus to compensate for small fluctuations in the film edge thickness without the partial opening disc needing to be positioned anew or repositioned.

The partial opening disc can be a polymer or a metallic partial opening disc. For example, the partial opening disc can be a high-temperature polymer partial opening disc, in particular a PEEK partial opening disc. If the partial opening disc is a metallic partial opening disc, its circumferential surface can be coated optionally at least partially. The coating can comprise, for example, a polymer coating (in particular PEEK). Thus, wear and tear and the mechanical stress on the blade flap and the partial opening disc can be minimized further.

The object is additionally solved by means of an opening system for opening grippers, in particular grippers of a stretching unit. The opening system comprises at least one partial opening device of the above type and a magnetic opening device, wherein the magnetic opening device is configured to open the grippers using magnetic force when the grippers are guided past the magnetic opening device. The magnetic force can be generated using at least one permanent magnet and/or using at least one electromagnet.

Furthermore, said at least one partial opening device can be positioned in the MD direction in such a way to carry out the pre-opening of grippers.

For pre-opening, the partial opening device is positioned, for example, in front of an effective region and/or at least partially in front of an effective region of the magnetic opening device, i.e. the partial opening device is upstream or positioned in its region. If the effective region of the magnetic opening device and the partial opening device overlap, the pre-opened grippers can be transferred simply to the magnetic opening device or only those grippers can be pre-opened which have a degree of opening below a predefined degree of opening when being guided past. Here, the predefined degree of opening is selected preferably in such a way that it corresponds to a degree of opening that the grippers would have attained through regular opening using the magnetic opening device. In this case, the partial opening device would thus ensure that all grippers have a certain (pre-opened) degree of opening after passing the partial opening device.

Furthermore, a partial opening device can be positioned in the MD direction in such a way to open the grippers fully. For full opening, the partial opening device is positioned, for example, after an effective region and/or at least partly in an effective region of the magnetic opening device. If the effective region of the magnetic opening device and the partial opening device overlap, the grippers opened already partly, but not completely can be transferred simply to the partial opening device. In this case, the predefined degree of opening is selected preferably in such a way that it corresponds to a degree of opening that the grippers would have attained typically when leaving the magnetic opening device. By means of full opening, the partial opening device can ensure that all grippers are opened after passing the partial opening device.

The effective region of the magnetic opening device is the region in which a magnetic force acts on the blade flap of the grippers which suffices to actuate the blade flap.

In particular, said at least one partial opening device can be positioned relative to the magnetic opening device in such a way that the contact point of the partial opening disc is positioned in the MD direction in a front region, in particular in a front third of the magnetic opening device (relative to a length L of the effective region of the magnetic opening device).

Furthermore, said at least one partial opening device can be positioned relative to the magnetic opening device in such a way that the contact point of the partial opening disc is located at a distance d before or after a point at which a maximum magnetic force acts on the grippers to be opened. In particular, the distance d can be in the range from L to L/2, preferably in the range from L to L/3 and particularly preferably in the range L to L/5 mm, wherein L indicates the length of the effective region of the magnetic opening device.

The distance is selected preferably in such a way that the partial opening disc engages in the region just before/after the maximum magnetic force as an opening of the grippers by the magnetic opening device will not take place after exceeding the maximum magnetic force. In addition, the partially opened gripper can be transferred or taken over by the partial opening device so that the gripper opens further, thus before the gripper starts to close itself again, but in any case, before the gripper is closed again.

In addition, the opening system can comprise a mechanical forced opening device, wherein the mechanical forced opening device is located in the direction of travel of the grippers after the magnetic opening device and the partial opening device. The forced opening device ensures that the grippers are opened without exception before these grip the material web again. In normal operation, the opening system is set in such a way that the opening occurs via the partial opening device and the magnetic opening device and is sufficient. The forced opening device is only used as a backup solution that is used, for example, if the partial opening device fails. The forced opening device can be an opening strip or a conventional opening wheel.

An opening strip is fixed. If a gripper not opened or only opened partially is guided past the opening strip, the blade flap rubs on the opening strip and is actuated in such a way that the gripper completely opens forcibly. Similarly, an opening wheel opens the gripper completely. In guiding the grippers past the stationary opening wheel, the opening wheel actuates the blade flap and thus opens the gripper completely.

Furthermore, the object is solved by means of a stretching unit, in particular a transverse direction orienter, a machine direction orienter and/or a simultaneous stretching unit comprising a multitude of grippers for gripping a material web to be stretched (e.g. film). In addition, the stretching unit comprises an opening system of the aforementioned type. Typically, the grippers are guided on at least two rails in a revolving manner, wherein the material web to be stretched is located between the rails. An opening system can be allocated to each of the rails.

In machine direction orienters, the material web is stretched in the longitudinal direction (MD direction). In transverse direction orienters, the material web is stretched in the transverse direction (TD direction). Machine and transverse direction orienters are often combined so that first there is longitudinal stretching and then transverse stretching (or vice versa). In simultaneous stretching units, the stretching in the machine and the transverse directions occurs simultaneously.

The stretching unit can be a film stretching unit, in particular for stretching plastic films, such as PET, PE, PP, PA and/or suchlike. The thicknesses of the end film can be in the range from 2 to 200 μm, preferably in the range from 2 to 100 μm and particularly in the range from 2 to 50 μm. The gripper travel speed is, for example, larger than 400 m/min, preferably larger than 500 m/min and particularly preferably larger than 600 m/min.

Moreover, the object is solved by a method for opening grippers, in particular grippers of a stretching unit, wherein the method comprises the following:
pre-opening of grippers by means of at least one partial opening device as described previously and
opening of the grippers using a magnetic opening device,
optional forced opening of the grippers using a mechanical forced opening device, after the grippers are guided past the partial opening device and the magnetic opening device without being opened successfully.

In addition to pre-opening, the grippers can also be opened fully. The method enables the reliable and wear-resistant opening of the grippers so that long service lives can be realised.

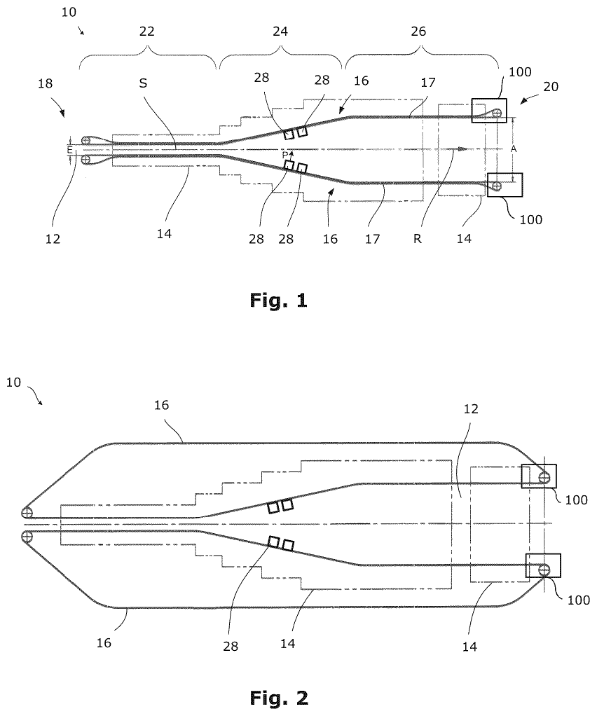

FIG. 1 and FIG. 2 each show an exemplary stretching unit 10. The stretching unit 10 comprises an oven 14 as well as two drive systems 16. The drive systems 16 are located here mirror-symmetrically with respect to an axis of symmetry S of the stretching unit 10 and extend at least partly into the oven 14. In an entry zone 18 as well as an exit zone 20, in which a material web 12 of the stretching unit 10 is fed and removed, the drive systems 16 run outside of the oven 14. It is understood that the drive systems 16 can also run completely within the oven 14.

In addition to the entry zone 18 and the exit zone 20, the stretching unit has at least three further zones 22, 24, 26. The zones 22, 24, 26 adjoin each other so that, as seen along the usual direction of travel and drawing direction R of the stretching unit 10, the entry zone 18 initially adjoins the first zone 22 that then adjoins the second zone 24 that then adjoins the third zone 26 that finally adjoins the exit zone 20.

The drive systems 16 have a first spacing to each other in the first zone 22 of the stretching unit 10 that adjoins the entry zone 18, said first zone 22 also being termed the preheating zone. Further zones can be adjoined after the heat treatment zone 26. Similarly, further zones can be provided between the described zones 22, 24, 26. For example, a cooling zone can be provided after the heat treatment zone 26, in said cooling zone, the stretched and heat-treated film is cooled further.

In the second zone 24, also termed the stretching zone, the spacing of both drive systems to each other increases until finally at the start of the third zone 26, also termed the heat treatment zone, a second spacing is reached.

Each of the drive systems 16 has a rail 17, on which a multitude of gripper units 28 are guided. The gripper units 28 can be moved along the rail 17 by means of a drive of the respective drive system 16. Similarly, it is also possible that the grippers are driven directly. In this case, the rails 17 are designed, for example, as linear motors.

In FIGS. 1 and 2, only two gripper units 28 per drive system 16 are each shown symbolically. The stretching unit 10 comprises however a multitude of gripper units 28 that are arranged along the rails 17.

The rails 17 of the respective drive systems 16 circle a closed path from the entry zone 18 to the exit zone 20 and back again. The rail section forming the forward travel extends in the intended direction of travel of the gripper units 28 between the entry zone 18 and the exit zone 20 within the oven 14.

The rail section that runs from the exit zone 20 to the entry zone 18 in the normal operating direction and forms the return is also located within the oven 14 in the shown embodiment (FIG. 1). As shown in the embodiment according to FIG. 2, it can however be located outside the oven 14.

To operate the stretching unit 10, the material web 12 to be stretched is fed into the entry zone 18 of the stretching unit 10 in the drawing direction R. To this end, the material web 12 is fixed to both drive systems 16 by means of its edges running in the drawing direction R.

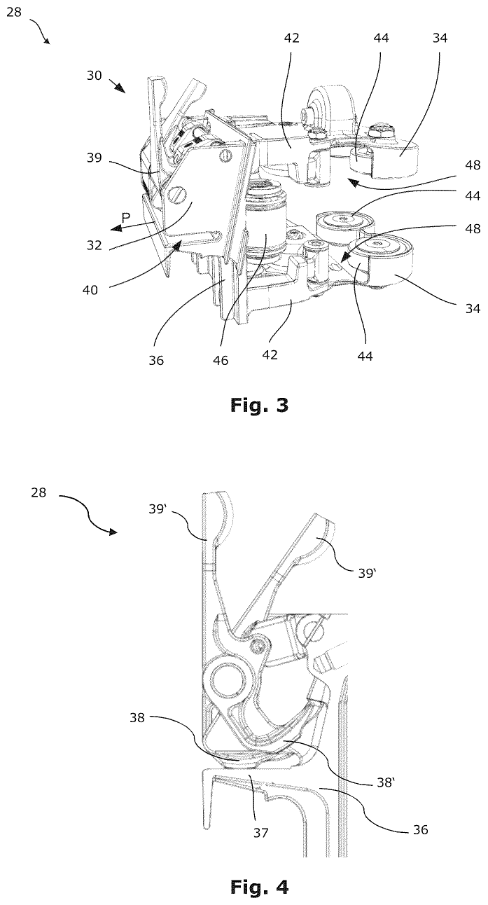

More specifically, the edges of the material web 12 (for example, an edge of a film) are fixed in position by a clamping device 30 (FIG. 3) of the gripper units 28 and thus moved by the movement of the gripper units 28 along the rails 17 of the drive systems 16 in the drawing direction (MD direction).

In the entry zone 18, the material web 12 has a width E perpendicular to the drawing direction R that corresponds approximately to the first spacing between the drive systems 16.

The material web 12 is then fed through the first zone 22 and heated there. In the subsequent second zone 24, thus the stretching zone, the material web 12 is stretched as the spacing of the drive systems 16 is increased continuously, in the TD direction and optionally in the MD direction. At the end of the second zone 24, the material web has a second width A.

After completing the stretching, the material web 12 passes through the third zone 26, in which a relaxation of the material web 12 can take place before the material web 12 is detached from the gripper units 28 in the exit zone 20 after prior cooling and leaves the stretching unit 10 with a width A.

For example, the stretching unit 10 is a transverse direction orienter. It is also conceivable that the stretching unit 10 is a machine direction orienter, in which material web is stretched in the longitudinal direction (thus drawing direction R).

In addition, the stretching unit 10 can be a simultaneous stretching unit, in which the material web 12 can be stretched in the second zone 24, thus the stretching zone, not only in the direction transverse to the drawing direction R but also in the drawing direction R.

During the processing of the material web 12, large tensile forces act on the gripper units 28 in a tensile direction, above all in the second zone 24, thus the stretching zone. The tensile direction is predominantly in a primary direction P of the gripper units 28 and to a lesser extent transverse to the primary direction P.

The gripper units 28 must be designed in such a way to withstand high tensile forces, in particular in their primary direction P. The primary direction P is thus that horizontal direction that runs transversely to an edge of the material web 12 received in the gripper unit 28.

To reliably absorb these tensile forces, the gripper units or grippers 28 are closed in the entry zone 18 and grip the material web 12. In the exit zone, the grippers are opened again and the stretched material web 12 is released. Opening systems 100 are provided for opening the grippers so that the grippers arrive in the opened state in the entry zone 18.

In FIG. 3, one of the grippers or gripper units 28 is shown in perspective view as an example. FIG. 4 is a detailed view (side view) of the gripper 28. The gripper unit 28 comprises a main part 32 as well as two guide parts 34. The main part 32 has a base body 36 and comprises the actual clamping device 30 that grips the material web 12.

The side of the base body 36, on which the clamping device 30 is provided, is also referred to as the material side. The other side, i.e. the side of the base body 36 without the clamping device 30 is referred to as the guide side as on this side the guide parts 34 are fixed. These guide parts 34 run on the rails 17 of the drive systems 16. Accordingly, the main part 32 comprises a material side and a guide side.

In the shown embodiment, the clamping device 30 is formed in the known manner from sections of the base body 36, in particular an integrally formed lower clamping face 37 and a blade flap 38 mounted rotatably on a base body 36, said blade flap 38 comprising the upper clamping face 38. The clamping device 30 defines a fixing section 40 or a fixing opening, in which the edge of the material web 12 to be fixed can be inserted into and fixed to the gripper unit 28 by means of the upper clamping face 38.

The primary direction P of the gripper unit 28 is perpendicular to the edge and the edge of the material web 12 that is fixed in position in the gripper unit 28. The primary direction P runs, for example, substantially to the left in FIG. 3. A fixed material web 12 exerts a tensile force on the gripper unit 28 in the second zone 24 (stretching zone) in the tensile direction, primarily in the primary direction P.

The guide parts 34 each comprise a base body 42 as well as at least one guide element 44 that is fixed to the base body 42. In the gripper unit 28 shown exemplary in FIG. 3, the guide parts 34 also comprise a drive element 46 that, for example, is a chain or are parts of a chain of the drive system 16. The drive element 46 can also be an engagement projection for a belt of the drive system 16 or part of a linear motor.

In the shown embodiment, the guide elements 44 are formed as rollers. In other embodiments, the guide elements 44 can however also be slide elements and/or magnetic elements, such as a permanent magnet or a ferromagnetic counterpart.

The guide parts 34 define a receiving space 48 for the rail 17 (also termed guide rail). In particular, a recess can be provided in each of the base bodies 42 of the guide parts 34, in said recess the rail 17 is received.

The receiving space 48 is located accordingly in front or on the guide side of the main part 32. The guide elements 44, in particular rollers and, if applicable, sliding elements, can project into the receiving space 48 and bear against the rail 17 and serve as a guide on the rail.

In FIG. 4, the clamping device 30 of the gripper/gripper unit 28 is shown in particular. The lower clamping face 37 is part of the base body 36 and designed rigidly. The upper clamping face 38 is moveable and can be moved from a closed position into an open position. To this end, the blade flap 39 is actuated. The upper clamping face and the blade flap in the closed position are denoted by the reference signs 38 and 39. The upper clamping face and the blade flap, in the closed position are denoted by the reference signs 38′ and 39′.

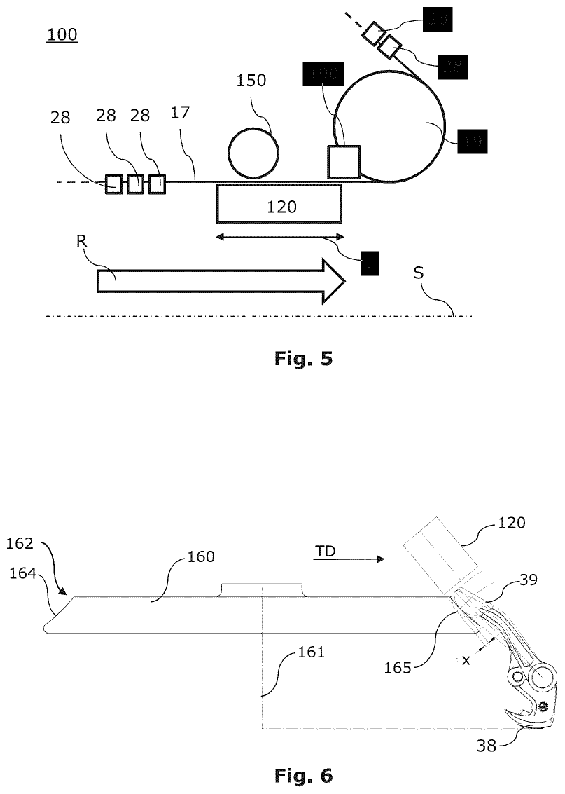

In FIG. 5, an opening system 100 for opening grippers 28, in particular grippers of a stretching unit 10, is shown schematically. The opening system 100 comprises a partial opening device 150 and a magnetic opening device 120. The magnetic opening device 120 is configured to open the grippers 28 using magnetic force when the grippers 28 on the rail 17 are guided past the magnetic opening device.

The partial opening device 150 is positioned in the MD direction in a front region, in particular in a front third of the magnetic opening device 120 (relative to the length L of the effective region of the magnetic opening device 120).

As is shown here, the effective region of the magnetic opening device 120 overlaps with the partial opening device 150 so that the pre-opened grippers can be transferred simply from the partial opening device 150 to the magnetic opening device 120. Depending on the application, the partial opening device 150 can be configured to pre-open only such grippers requiring pre-opening in order to then be completely opened by the partial opening device (first application), or the partial opening device 150 can be configured to pre-open all grippers 28 being guided past (second application).

In the shown embodiment, the grippers 28 are opened in the exit zone 20 by means of the opening system 100 and returned via the deflector 19 on the rail 17 to the entry zone 18, in order to grip the material web 12 again.

If the grippers 28 cannot be opened successfully, for example due to a malfunction of the partial opening device 150 and/or the magnetic opening device 120, a forced opening device 190 can be provided that forces the opening of the grippers before reaching the entry zone 18 again.

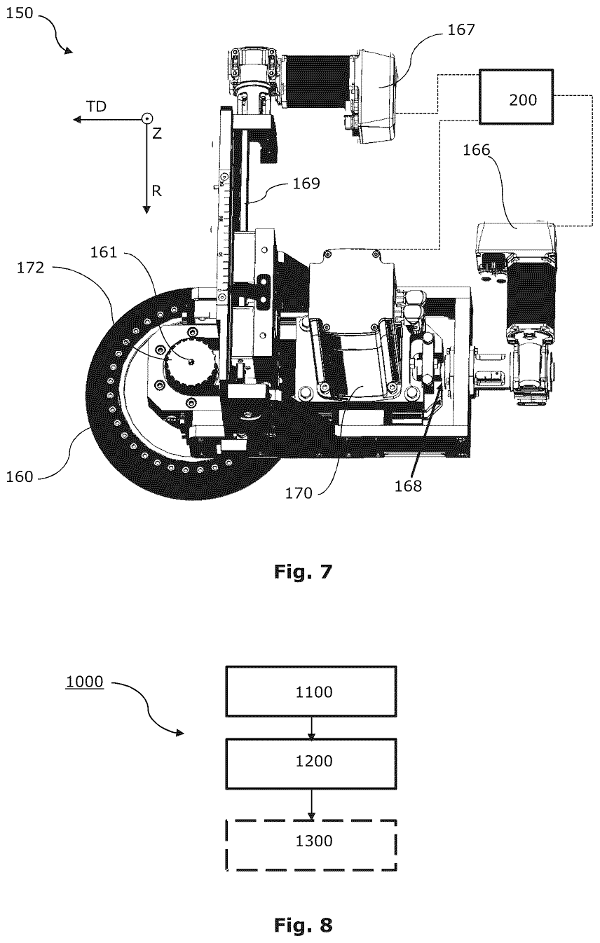

FIG. 6 shows a schematic view of a partial opening disc 160 of a partial opening device 150, as it is shown for example in FIG. 7. The partial opening disc 160 can be driven rotatably about the axis of rotation 161.

The partial opening disc 160 has a circumferential surface 162 comprising a rotating contact surface 164. This contact surface 164 engages with a blade flap 39 of a gripper 28 when the gripper 28 is guided past the partial opening disc 160 so that the gripper 28 is pre-opened or opened fully. In the example shown here, the blade flap 39 of the gripper is actuated by the partial opening disc 160 in such a way that the upper clamping face 38 of the gripper is moved from a closed position into a partially open position. The gripper is thus pre-opened and then transferred to a magnetic opening device 120 for further opening.

Similarly, it is also possible that the blade flap 39 of the gripper is actuated by the partial opening disc 160 in such a way that the upper clamping face 38 of the gripper is moved from a partially open position to a completely open position. The gripper is thus opened fully once it has been taken over by the magnetic opening device 120.

As shown in FIG. 6, the partial opening disc is positioned in the MD and TD directions in such a way that the blade flap 39 is moved or actuated by a distance X from the time of the first contact with the partial opening disc 160 at the contact point 165 until its removal from the partial opening disc 160. The distance X or the position of the partial opening disc 160 can be measured in such a way that that gripper is pre-opened in a degree-of-opening range that is greater than 0% to at least 5%, preferably to at least 10% and particularly preferably to at least 15%. Similarly, the distance X or the position of the partial opening disc 160 can be measured in such a way that that gripper is opened fully from a degree of opening of at least 95%, preferably 90% and particularly preferably at least 85%. The percentages relate to a distance that the upper clamping face 38 of the gripper travels transitioning from the closed state to the opened state.

FIG. 7 shows a schematic view of a partial opening device 150 as it can be used for pre-opening or full opening. In principle, such partial opening devices can be retrofitted into existing opening systems or be part of an opening system 100. The partial opening device 150 comprises a partial opening disc 160 that can be designed as shown in FIG. 6. In addition, the partial opening device 150 comprises a drive 170. The drive can be a direct drive or an indirect drive. For example, the drive can comprise a synchronous motor as well as a belt drive 172 or a chain. The drive 170 drives the partial opening disc 160 rotatably. In doing so, the drive 170 can be synchronised with the gripper travel speed in such way that the contact surface 164 of the partial opening disc 160, compared to a gripper 28 to be opened partly, has slip in the range of −10% to +10%, preferably in the range of −5% to +5% and particularly in the range of 0% to +3%.

Furthermore, the shown partial opening device 150 comprises a positioning device 166, 167, which can adjust, for example, the position of the partial opening disc in the TD direction and/or MD direction R via screw drives 168, 169. Furthermore, the position of the partial opening disc 160 can be adjustable in the vertical direction Z. To this end, a further positioning device (not shown) can be provided.

In particular, the partial opening device 150 can comprise a control device 200 that can change the speed of the partial opening disc 160.

FIG. 8 shows a schematic view of a method 1000 for opening grippers 28, in particular grippers 28 of a stretching unit 10, wherein the method comprises the following:
pre-opening 1100 of grippers by means of at least one partial opening device 150 as described above,
opening 1200 of the grippers using a magnetic opening device 120, and
optional forced opening 1300 of the grippers using a mechanical forced opening device, after the grippers have been guided past the partial opening device and the magnetic opening device without being opened successfully.

It is understood that the steps 1100 and 1200 are executed during pre-opening in the specified order. Initially a pre-opening, then an opening and finally a full opening can also take place. The forced opening is however downstream of the steps 1100 and 1200 and is only executed—if implemented—in case of an emergency. If the partial opening device is configured to pre-open such grippers requiring pre-opening in order to be opened completely (first application), the grippers can also only be opened by means of the magnetic opening device 120. This applies to the grippers that have attained at least the predefined degree of opening when being guided past the partial opening device, thus have been opened by then sufficiently by the opening device. The technology herein can of course be designed in another way as set out at present without impairing any features of example embodiments as a result. The present embodiments are exemplary in every respect and are not to be considered restrictively; and all modifications that fall under the doctrine of equivalents of the enclosed claims are to be included in it.

### LIST OF REFERENCE SIGNS

10 stretching unit
12 material web
14 oven
16 drive system
17 rail
18 entry zone
19 deflector
20 exit zone
22 first zone (preheating zone)
24 second zone (stretching zone)
26 third zone (heat treatment zone)
28 gripper unit
30 clamping device
32 main part
34 guide part
36 base body
37 lower clamping face
38 upper clamping face
39 blade flap
40 fixing section
42 base body
44 guide element
46 drive element
48 receiving space
100 opening system
120 magnetic opening device
150 partial opening device
160 partial opening disc
161 axis of rotation
162 circumferential surface
164 contact surface
165 contact point
166 positioning device
167 positioning device
168 screw drive
169 screw drive
170 drive
172 belt drive
190 forced opening device
200 control device
1000 method
1100 partial opening (pre-opening or full opening)
1200 opening
1300 forced opening
A width of the material web at the end of the stretching zone
E width of the material web in the entry zone
P primary direction of the tensile direction
R drawing direction (MD direction)
S axis of symmetry
TD TD direction
X distance
Z vertical direction
L length of the effective region of the magnetic opening device

What is claimed is:

1. Partial opening device for the pre-opening of grippers comprising
at least one partial opening disc and a drive, wherein the drive is configured to drive said at least one partial opening disc, and wherein
the partial opening disc has a circumferential surface comprising a rotating contact surface, wherein the contact surface is configured to engage with a blade flap of a gripper when
the gripper is guided past the partial opening disc, and when the blade flap, when being guided past the partial opening disc, has a degree of opening below a predefined degree of opening so that the gripper is pre-opened.

2. Partial opening device according to claim 1, wherein the drive is configured to be synchronised with a gripper travel speed in such way that the contact surface of the partial opening disc, compared to a gripper to be opened partly, has slip in the range of −10% to +10%, preferably in the range of −5% to +5% and particularly in the range of 0% to +3%.

3. Partial opening device according to claim 1, wherein
the drive is a direct drive, or wherein
the drive is an indirect drive that can comprise a belt drive or a chain drive.

4. Partial opening device according to claim 1, wherein a position of the partial opening device is adjustable in the TD direction and/or MD direction, wherein the partial opening device comprises preferably at least one positioning device for adjusting the position of the partial opening disc in the TD direction and/or MD direction.

5. Partial opening device according to claim 1, wherein the position of the partial opening disc is adjustable in the vertical direction.

6. Partial opening device according to claim 4, wherein the partial opening device comprises in addition a control device that can change the position of the partial opening disc.

7. Partial opening device according to claim 1, wherein
the contact surface of the partial opening disc comprises contoured cross section, wherein the contoured cross section is adapted to a contact region of a blade flap of a gripper to be opened partly, preferably in such a way that a position of the contact point in the MD direction is independent of the film edge thickness of the material web held by the gripper to be opened partly.

8. Partial opening device according to claim 1, wherein the partial opening disc is a polymer partial opening disc, or wherein
the partial opening disc is a metallic partial opening disc, and wherein optionally the circumferential surface is coated at least partly, wherein the coating can comprise a polymer coating.

9. Opening system for the opening of grippers, in particular grippers of a stretching unit, the opening system comprising
at least one partial opening device according to claim 1; and a
magnetic opening device, wherein the magnetic opening device is configured to open the grippers using magnetic force when the grippers are guided past the magnetic opening device, and wherein
said at least one partial opening device is positioned in the MD direction (R) in such a way to carry out a pre-opening of the grippers.

10. Opening system according to claim 9, wherein said at least one partial opening device is positioned relative to the magnetic opening device in such a way that the contact point of the partial opening disc is positioned in the MD direction in a front region, in particular in a front third of the magnetic opening device.

11. Opening system according to claim 9, wherein the partial opening device can be positioned relative to the magnetic opening device in such a way that the contact point of the partial opening disc is located at a distance before or after a point at which a maximum magnetic force acts on the grippers to be opened.

12. Opening system according to claim 9, wherein the opening system comprises in addition a mechanical forced opening device, wherein the mechanical forced opening device is located in the direction of travel of the grippers after the magnetic opening device and the partial opening device.

13. Stretching unit, in particular a transverse direction orienter, a machine direction orienter and/or a simultaneous stretching unit, comprising
a multitude of grippers for gripping a material web to be stretched, in particular a film, and
opening system according to claim 9.

14. Stretching unit according to claim 13, in particular film stretching unit, wherein the stretching unit has a gripper travel speed of greater than 400 m/min, preferably greater than 500 m/min and particularly preferably greater than 600 m/min.

15. Method for opening grippers, in particular grippers of a stretching unit, wherein the method comprises:
pre-opening of grippers by means of at least one partial opening device according to claim 1 when the grippers are guided past the partial opening disc and if the gripper, when being guided past the partial opening disc, has a degree of opening below a predefined degree of opening, and
opening of the grippers using a magnetic opening device, and
optional forced opening of the grippers using a mechanical forced opening device, after the grippers are guided past the partial opening device and the magnetic opening device without being opened successfully.
